(19) United States
(12) Patent Application Publication
(10) Pub. No.: US 2025/0279581 A1
(43) Pub. Date: Sep. 4, 2025

(54) PHASE SHIFTER, ANTENNA, AND BASE STATION

(71) Applicant: Huawei Technologies Co., Ltd., Shenzhen (CN)

(72) Inventors: Fuwei Lei, Xi’an (CN); Aifeng Wang, Xi’an (CN); Maobin Li, Dongguan (CN); Xinming Liu, Xi’an (CN); Lang Liu, Dongguan (CN)

(21) Appl. No.: 19/210,178

(22) Filed: May 16, 2025

Related U.S. Application Data
(63) Continuation of application No. PCT/CN2023/125728, filed on Oct. 20, 2023.

(30) Foreign Application Priority Data
Nov. 18, 2022 (CN) 202211447902.0

(51) Int. Cl. H01Q 3/32; H01P 1/18; H01Q 1/24

(52) U.S. Cl. CPC H01Q 3/32; H01P 1/18; H01Q 1/246

(57) ABSTRACT

This application provides a phase shifter. The phase shifter includes a phase shift assembly including a substrate, a rotating arm, a drive arm, and a drive assembly. An output line is disposed on the substrate, and the output line includes an arc-shaped segment. The rotating arm is rotatably connected to the substrate through a rotating shaft, a coupling line is disposed on the rotating arm, and the coupling line is electrically connected to the arc-shaped segment. One end of the drive arm is fastened to the rotating arm, and the other end extends to a side that is of the rotating shaft and that faces away from the output line, and is in transmission connection to the drive assembly. The drive assembly drives the drive arm to move, and the drive arm drives the rotating arm to rotate relative to the substrate.

### CROSS-REFERENCE TO RELATED APPLICATIONS

This application is a continuation of International Application No. PCT/CN2023/125728, filed on Oct. 20, 2023, which claims priority to Chinese Patent Application No. 202211447902.0, filed on Nov. 18, 2022. The disclosures of the aforementioned applications are hereby incorporated by reference in their entireties.

### TECHNICAL FIELD

This application relates to the field of communication technologies, and specifically, to a phase shifter, an antenna, and a base station.

### BACKGROUND

An antenna of a base station implements beam downtilt adjustment through a phase shifter, and has many advantages such as a large downtilt angle adjustable range, high precision, an easily controlled directivity pattern, a strong anti-interference capability, and easy remote control. The phase shifter is one of core components of the antenna, and performance of the phase shifter directly affects overall performance of the antenna.

In a related technology, a problem of the phase shifter is that a relatively large force is required to drive a rotating arm to rotate, and consequently power costs of the phase shifter are relatively high, and it is not conducive to energy conservation.

### SUMMARY

This application provides a phase shifter, an antenna, and a base station, to reduce a requirement of the phase shifter for power performance of a drive assembly, and alleviate a problem that a relatively large force is required to drive a rotating arm to rotate in a phase shifter in a related technology.

According to a first aspect, this application provides a phase shifter. The phase shifter includes a phase shift assembly. There may be one phase shift assembly, or may be a plurality of phase shift assemblies. When the phase shift assembly is specifically disposed, the phase shift assembly includes a substrate and a rotating arm, an output line is disposed on the substrate, and the output line includes an arc-shaped segment. A coupling line is disposed on the rotating arm, the rotating arm is rotatably disposed on the substrate through a rotating shaft, and the coupling line is electrically connected to the arc-shaped segment. The phase shift assembly further includes a drive arm and a drive assembly. One end of the drive arm is fastened to the rotating arm, and the other end of the drive arm extends to a side that is of the rotating shaft and that faces away from the output line, and is in transmission connection to the drive assembly. Specifically, the drive assembly drives the drive arm to swing, the drive arm drives the rotating arm to swing relative to the substrate, and in a process in which the rotating arm swings relative to the substrate, the coupling line slides along the arc-shaped segment of the output line. In this solution, the rotating arm is rotatably disposed on the substrate, and implements a transmission connection to the drive assembly through the drive arm extending to a side that is of a rotating shaft (the foregoing rotating shaft) and that faces away from the output line. A force arm acting on the rotating shaft is extended through the drive arm, so that the rotating arm can be driven, by using a relatively small force, to rotate, and the phase shifter has a lower requirement for power performance of the drive assembly.

When the fastened connection between the rotating arm and the drive arm is specifically implemented, in a technical solution, the rotating arm and the drive arm may be an integrated structure, to reduce a quantity of components of the phase shifter while connection reliability of the rotating arm and the drive arm is improved, thereby improving assembly efficiency and a lightweight degree of the phase shifter. In another technical solution, both the rotating arm and the drive arm may be independent components, and the two components are fastened to each other in a welding manner, a riveting manner, a bonding manner, or the like.

When the drive assembly is specifically disposed, the drive assembly may include a power output end, the power output end is in transmission connection to the drive arm, and the drive assembly drives the power output end to reciprocate along a first direction, so that the power output end drives the drive arm to drive the rotating arm to rotate, to implement a phase shift. In this solution, swing of the rotating arm is driven through rectilinear movement of the power output end, to help reduce a size of the phase shifter in a second direction. The second direction is a direction that is in a same plane in which the substrate is located as the first direction and that is perpendicular to the first direction.

In a specific technical solution, the first direction is in a same plane as a symmetry axis of the arc-shaped segment of the output line, and the first direction is perpendicular to the symmetry axis of the arc-shaped segment. In this solution, a movement path of the power output end is parallel to an edge of the substrate, so that the movement path of the power output end is shorter, thereby helping further improve miniaturization and a lightweight property of the phase shifter.

When the rotating shaft is specifically disposed, the rotating shaft may be located on the symmetry axis of the arc-shaped segment of the output line, so that a swing path of the rotating arm is symmetrical about the symmetry axis, thereby helping simplify a structural design of the output line, and design of a running parameter of the drive assembly, and the like.

When the transmission connection between the power output end and the drive arm is specifically implemented, in an optional technical solution, a guide trough extending along a length direction of the drive arm may be disposed on the drive arm, and the power output end includes a push shaft. The push shaft is inserted into the guide trough, and is driven by the drive assembly to push the drive arm and slide relative to the guide trough, to drive the drive arm to rotate. The transmission connection between the power output end and the drive arm is implemented through fitting between the push shaft and the guide trough. On one hand, a quantity of components is relatively small, and assembly efficiency is relatively high. On the other hand, fitting between the push shaft and the guide trough can further play a guiding role and a limiting role, to help ensure accuracy of a movement path of the rotating arm, and ensure reliable contact between the coupling line and the arc-shaped segment of the output line, thereby ensuring phase shift reliability.

In another optional technical solution, the phase shift assembly may include a sliding sleeve, and the sliding sleeve is sleeved onto the drive arm, and can slide relative to the drive arm along a length direction of the drive arm. In addition, an insertion hole is disposed in the sliding sleeve, and an axial direction of the insertion hole is parallel to an axial direction of the rotating shaft. A push shaft is inserted into the insertion hole, and can rotate relative to the insertion hole, to implement the transmission connection between the power output end and the drive arm through fitting between the push shaft and the sliding sleeve.

In a specific technical solution, the phase shift assembly may further include an elastic crimping assembly, and the elastic crimping assembly is fastened to the rotating arm, and clamps the substrate and the rotating arm, to apply an abutting force toward the substrate to the rotating arm. In this way, all gaps between the coupling line and the arc-shaped segment of the output line can be o, thereby ensuring reliable contact between the coupling line and the arc-shaped segment of the output line, and maintaining a stable and reliable coupled connection relationship between the coupling line and the output line.

When the elastic crimping assembly is specifically disposed, the elastic crimping assembly may include a crimping body, a crimping foot group, and a transition connecting part. The crimping foot group is located on a side that is of the substrate and that faces away from the rotating arm, and abuts against and is slidably connected to a surface that is of the substrate and that faces away from the rotating arm. The crimping body is fastened to a side that is of the rotating arm and that faces away from the substrate, and an elastic crimping part configured to press the rotating arm toward the substrate is disposed. The transition connecting part connects the crimping body and the crimping foot group. In this solution, the elastic crimping assembly is more conveniently disposed, and an effect of pressing the rotating arm toward the substrate by the elastic crimping assembly is more reliable.

In a specific technical solution, the substrate may have an arc-shaped edge, and the arc-shaped edge is located on a side that is of the output line and that faces away from the rotating shaft. The elastic crimping assembly slidably fits with the arc-shaped edge, to guide swing of the rotating arm through fitting between the elastic crimping assembly and the arc-shaped edge, so that the electrical connection between the coupling line and the arc-shaped segment of the output line is more reliable. The crimping foot group may include at least two crimping feet, the transition connecting part may include at least two connecting arms, and the crimping feet are spaced apart along an extension direction of the arc-shaped edge. The at least two connecting arms are connected to the at least two crimping feet in one-to-one correspondence, so that the elastic crimping assembly clamps the substrate and the rotating arm in the elastic crimping assembly. Space between two adjacent connecting arms may form a slot. An insertion block adapted to the slot is disposed at an end that is of the rotating arm and that is close to the arc-shaped edge, and the insertion block is inserted into the slot. This can implement a connection between the rotating arm and the elastic crimping assembly at this end through the insertion block and the slot, and also help improve a positioning speed and positioning accuracy between the elastic crimping assembly and the rotating arm during assembly of the phase shifter.

When the crimping body is specifically disposed, a hollow area may be disposed on the crimping body, and the elastic crimping part includes a spring plate disposed in the hollow area, to apply a force toward the substrate to the rotating arm through the spring plate. In this solution, the force toward the substrate can be applied to the rotating arm through a relatively small quantity of components, to help simplify a structure of the elastic crimping assembly, and also help improve crimping reliability.

In an optional technical solution, a quantity of hollow areas on the crimping body is the same as a quantity of output lines disposed on the substrate, and each output line is opposite to a spring plate in one hollow area. In this solution, each output line is opposite to a spring plate in one hollow area, and the spring plate applies an abutting force to the output line. This helps ensure a reliable connection and a o gap between an arc-shaped segment of each output line and the coupling line.

When the substrate is specifically disposed, two output lines may be disposed on the substrate, and the two output lines may be respectively denoted as a first output line and a second output line. A circle center of an arc-shaped segment of the first output line coincides with a circle center of an arc-shaped segment of the second output line, the first output line is farther away from the rotating shaft than the second output line, and both the arc-shaped segment of the first output line and the arc-shaped segment of the second output line are electrically connected to the coupling line. In this solution, the two output lines are disposed on the substrate, and each output line has two signal output ends, so that an antenna can transmit more signals.

In a specific technical solution, a main feeder and a coupling part are disposed on the substrate, both the main feeder and the coupling part are located on a side that is of the output line and that faces the rotating shaft, the main feeder is electrically connected to the coupling part, and an extension direction of the main feeder is parallel to the first direction, to help reduce a size occupied by the main feeder in the second direction, and facilitate miniaturization and a lightweight property of the phase shifter.

A third output line may be further disposed on the substrate, to further increase a quantity of signals transmitted by the antenna. The third output line is located on the side that is of the output line and that faces the rotating shaft, and is electrically connected to the coupling part. An extension direction of the third output line is parallel to the first direction, to reduce a size occupied by the third output line in the second direction, and facilitate miniaturization and a lightweight property of the phase shifter.

In a specific technical solution, there are a plurality of phase shift assemblies, and the plurality of phase shift assemblies are sequentially disposed along the axial direction of the rotating shaft, to reduce a volume of the phase shifter.

When the phase shift assembly is specifically disposed, in an optional technical solution, the phase shift assembly includes a shielding panel, the substrate is fastened to the shielding panel, and the rotating arm is located on a side that is of the substrate and that faces away from the shielding panel. In this solution, the shielding panel can play a support role, to improve structural strength of the phase shift assembly, and can also reduce or even shield signal interference between two adjacent phase shift assemblies. One panel is used for two purposes, to help reduce a thickness of the phase shifter, thereby reducing space occupied by the phase shifter.

According to a second aspect, this application provides an antenna. The antenna includes a radiating element and the phase shifter in the first aspect. The radiating element is electrically connected to the phase shifter, and the phase shifter is configured to adjust a feeding phase of the radiating element. A requirement for power performance of the drive assembly in the phase shifter is relatively low, so that energy consumption of the antenna is lower.

According to a third aspect, this application provides a base station. The base station includes a mounting bracket and the antenna in the second aspect. The antenna is disposed on the mounting bracket, and is configured to receive or transmit a signal. The antenna has relatively low energy consumption, to help energy conservation of the base station.

### BRIEF DESCRIPTION OF THE DRAWINGS

FIG. 1 is a diagram of an application scenario of a base station according to a possible embodiment of this application;

FIG. 2 is a diagram of a structure of a base station according to a possible embodiment of this application;

FIG. 3 is a diagram of a structure of an antenna according to a possible embodiment of this application;

FIG. 4 is a front view of a phase shifter in a related technology;

FIG. 5 is a front view of a phase shifter according to a possible embodiment of this application;

FIG. 6 is an exploded view of the phase shifter shown in FIG. 5;

FIG. 7 is a diagram of a structure of a rotating arm and a drive arm in a phase shifter according to a possible embodiment of this application;

FIG. 8 is a diagram of a working principle of a phase shifter according to a possible embodiment of this application;

FIG. 9 is a diagram of a partial structure of a phase shifter according to a possible embodiment of this application;

FIG. 10 is a diagram of a connection relationship between a push shaft and a drive arm according to a possible embodiment of this application;

FIG. 11 is a diagram of a partial structure of a phase shifter according to another possible embodiment of this application;

FIG. 12 is a diagram of a structure of an elastic crimping assembly of a phase shifter according to a possible embodiment of this application;

FIG. 13 is a diagram of a structure of an elastic crimping assembly, a rotating arm, and a substrate according to an embodiment of this application; and

FIG. 14 is a diagram of a structure of a phase shifter according to another possible embodiment of this application.

### REFERENCE NUMERALS

100: antenna; 101: radome; 102: radiating element; 103: reflection panel; 200: mounting bracket; 300: antenna adjustment bracket; 400: radio frequency processing unit; 500: baseband processing unit; 600: cable; 700: antenna connector; 810: adjustment unit; 811: transmission structure; 812: calibration network; 820: combiner; 830: filter; and 900: grounding device;

1′: phase shifter; 11′: substrate; 12′: rotating shaft; 13′: rotating arm; and 14′: drive assembly;

1: phase shifter; 10: phase shift assembly; 10a: first phase shift assembly; and 10b: second phase shift assembly;

11: substrate; 111: output line; 111a: first output line; 111b: second output line; 1111: arc-shaped segment; 1112: first output segment; 1113: second output segment; 112: rotating shaft mounting hole; 113: main feeder; 114: coupling part; and 115: third output line;

12: rotating shaft; 13: rotating arm; 131: hole; 132: coupling line; and 133: insertion block;

14: drive assembly; 141: power output end; 142: push shaft; 1421: shaft body; and 1422: stopper;

15: drive arm; 151: guide trough; 1511: avoiding hole; and 16: sliding sleeve;

17: elastic crimping assembly; 171: crimping body; 1711: through hole; 1712: hollow area; 172: crimping foot group; 1721: crimping foot; 173: transition connecting part; 1731: connecting arm; 174: elastic crimping part; 1741: spring plate body; 1742: crimping protrusion; 1743: elastic member; 1744: crimping member; and 1700: slot; and

18: shielding panel; and 19: metal housing.

### DETAILED DESCRIPTION OF ILLUSTRATIVE EMBODIMENTS

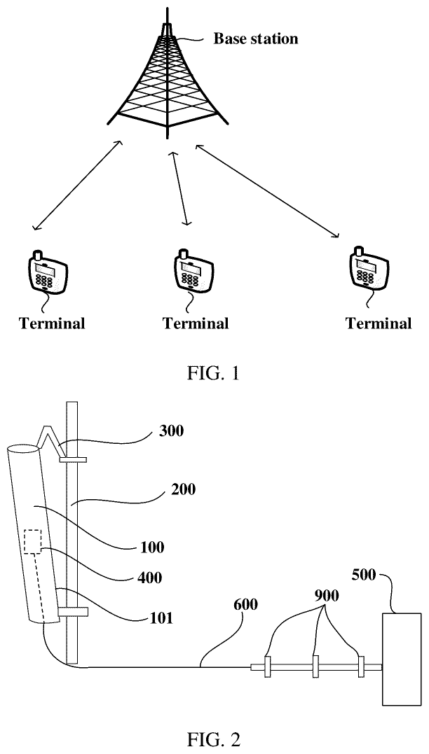

For ease of understanding a phase shifter, an antenna, and a base station provided in embodiments of this application, the following describes an application scenario of the phase shifter, the antenna, and the base station. FIG. 1 is a diagram of an example of an application scenario of a base station according to an embodiment of this application. As shown in FIG. 1, the application scenario may include a base station and a terminal. Wireless communication may be implemented between the base station and the terminal. The base station may be located in a base station subsystem (BSS), a UMTS terrestrial radio access network (UTRAN), or an evolved universal terrestrial radio access network (E-UTRAN), and is configured to perform cell coverage of a radio signal, to implement communication between a terminal device and a wireless network. Specifically, the base station may be a base transceiver station (BTS) in a global system for mobile communications (GSM) or a code division multiple access (CDMA) system, may be a NodeB (NB) in a wideband code division multiple access (WCDMA) system, may be an evolved NodeB (eNB or eNodeB) in a long term evolution (LTE) system, or may be a radio controller in a cloud radio access network (CRAN) scenario. Alternatively, the base station may be a relay station, an access point, a vehicle-mounted device, a wearable device, a g node (gNodeB or gNB) in a new radio (NR) system, a base station in a future evolved network, or the like. This is not limited in this embodiment of this application.

FIG. 2 is a diagram of a structure of a base station according to an embodiment of this application. The base station may usually include an antenna 100, a mounting bracket 200, an antenna adjustment bracket 300, and other structures. The antenna 100 of the base station includes a radome 101. The radome 101 has a good electromagnetic wave penetration property in terms of electrical performance, and can withstand impact of an external harsh environment in terms of mechanical performance, so that the antenna 100 can be protected from impact of an external environment. The antenna 100 may be mounted on the mounting bracket 200 through the antenna adjustment bracket 300, to facilitate receiving or transmitting of a signal of the antenna 100.

In addition, the base station may further include a radio frequency processing unit 400 and a baseband processing unit 500. For example, the radio frequency processing unit 400 may be configured to: perform frequency selection, amplification, and down-conversion processing on a signal received by the antenna 100, convert the signal into an intermediate frequency signal or a baseband signal, and send the intermediate frequency signal or the baseband signal to the baseband processing unit 500. Alternatively, the radio frequency processing unit 400 is configured to: perform up-conversion and amplification processing on a baseband signal or an intermediate frequency signal of the baseband processing unit 500, convert the signal into an electromagnetic wave through the antenna 100, and send the electromagnetic wave. The baseband processing unit 500 may be connected to a feeding network of the antenna 100 through the radio frequency processing unit 400. In some implementations, the radio frequency processing unit 400 may also be referred to as a remote radio unit (RRU), or may be a radio frequency module in an active antenna unit (AAU). The baseband processing unit 500 may also be referred to as a baseband unit (BBU).

In a possible embodiment, as shown in FIG. 2, the radio frequency processing unit 400 and the antenna 100 may be integrally disposed, and the baseband processing unit 500 is located at a remote end of the antenna 100. In some other embodiments, both the radio frequency processing unit 400 and the baseband processing unit 500 may be located at a remote end of the antenna 100. The radio frequency processing unit 400 and the baseband processing unit 500 may be connected through a cable 600.

More specifically, refer to FIG. 2 and FIG. 3 together. FIG. 3 is a diagram of a structure of an antenna according to a possible embodiment of this application. As shown in FIG. 3, the antenna 100 of the base station may include a radiating element 102 and a reflection panel 103. The radiating element 102 may also be referred to as an antenna element, an element, or the like, and can effectively send or receive an antenna signal. In the antenna 100, frequencies of different radiating elements 102 may be the same or different. The reflection panel 103 may also be referred to as a bottom plate, an antenna panel, a reflective surface, or the like, and may be made of metal. When the antenna 100 receives a signal, the reflection panel 103 may reflect the antenna signal to a target coverage area. When the antenna 100 transmits a signal, the reflection panel 103 may reflect and transmit the signal transmitted to the reflection panel 103. The radiating element 102 is usually placed on a surface of one side of the reflection panel 103. This can greatly enhance a signal receiving or transmitting capability of the antenna 100, and can also block and shield interference caused to antenna signal receiving by another electromagnetic wave from a rear face of the reflection panel 103 (in this application, the rear face of the reflection panel 103 is a side opposite to the side that is of the reflection panel 103 and that is configured to dispose the radiating element 102).

The antenna is connected to the radio frequency processing unit 400 through an antenna connector 700 located outside the radome 101. In the antenna 100, a feeding network is disposed between the radiating element 102 and the antenna connector 700. The feeding network may provide specific power and a specific phase for the radiating element 102. As shown in FIG. 3, the feeding network may include an adjustment unit 810 and a phase shifter 1. The phase shifter 1 is configured to change a maximum direction of signal radiation. The phase shifter 1 correspondingly adjusts corresponding radiating elements 102, so that electrical downtilt angles of radiation signals of the radiating elements 102 may be changed, to change radiation directions of the radiating elements 102, thereby meeting a signal coverage requirement. The adjustment unit 810 is configured to implement different radiation beam directions, and may specifically include a transmission structure 811 and a calibration network 812. The transmission structure 811 may drive the phase shifter 1 to change directions of different radiation beams. The calibration network 812 sends a calibration signal to the transmission structure 811 to control an action of the transmission structure 811.

Still refer to FIG. 3. Some modules used for performance extension may be further disposed in the feeding network. For example, a combiner 820 may be further disposed. The combiner 820 may be configured to: combine signals of different frequencies into one signal, and transmit the signal through the antenna 100; or during reverse use, the combiner 820 may be configured to: divide a signal received by the antenna 100 into a plurality of signals based on different frequencies, and transmit the signals to the baseband processing unit 500 for processing. For another example, a filter 830 may be further disposed. The filter 830 is configured to filter out an interference signal.

In a specific embodiment, a grounding device 900 may be disposed between the baseband processing unit 500 and the cable 600, and the grounding device 900 usually includes a ground electrode buried underground. A sealing member may be disposed at a connecting place between the antenna 100 and the cable 600, and a sealing member may also be disposed at a connecting place between the grounding device 900 and the cable 600. The sealing member may specifically include at least one of an insulation sealing tape and a polyvinyl chloride (PVC) insulation tape. Certainly, the sealing member may alternatively be another structure, and is not limited to a tape form.

It is worth noting that any embodiment related to the term “specific”, such as “specifically”, “specifically disposed”, and “specifically designed” in this application is an optional embodiment. In other words, the embodiment is a possible specific embodiment under the inventive concept of this application, but other possible embodiments may be further included.

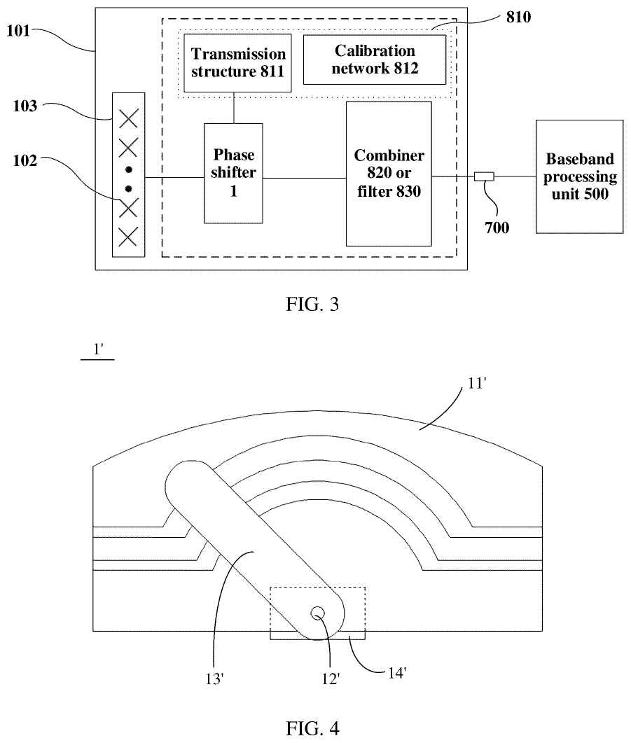

FIG. 4 is a front view of a phase shifter in a related technology. As shown in FIG. 4, in the related technology, a phase shifter 1′ includes a substrate 11′, a rotating shaft 12′, a rotating arm 13′, and a drive assembly 14′. The rotating shaft 12′ is disposed on the substrate 11′, and can rotate relative to the substrate 11′. One end of the rotating arm 13′ is fastened to the rotating shaft 12′. The drive assembly 14′ directly acts on the rotating shaft 12′ to drive the rotating shaft 12′ to rotate, to drive the rotating arm 13′ to rotate relative to the substrate 11′, thereby implementing a phase shift. In this solution, a force driving the rotating shaft 12′ to rotate directly acts on the rotating shaft 12′, and a force arm acting on the rotating shaft 12′ is almost zero. Torque is a product of the force and the force arm. To enable the rotating shaft 12′ to rotate, a relatively large force is required. As a result, the phase shifter 1′ has excessively large transmission resistance, the phase shifter 1′ has a higher requirement for power performance of the drive assembly 14′, and energy consumption is higher. In addition, because the phase shifter 1′ has excessively large transmission resistance, the drive assembly has a relatively large transmission weight (the drive assembly has relatively large transmission resistance), and a failure rate of vibration joint adjustment is relatively high.

In view of this, embodiments of this application provide a phase shifter 1, an antenna, and a base station, to alleviate the foregoing problem.

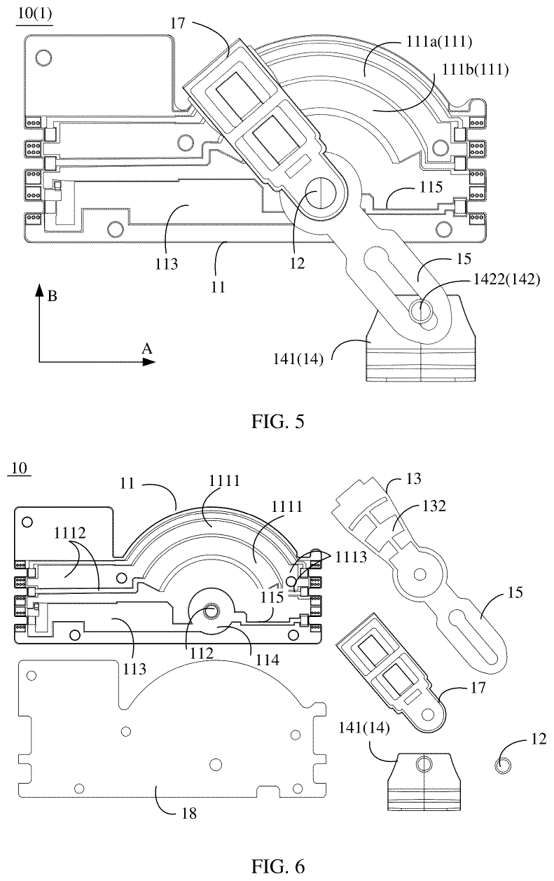

FIG. 5 is a front view of a phase shifter according to an embodiment of this application. FIG. 6 is an exploded view of the phase shifter shown in FIG. 5. As shown in FIG. 5 and FIG. 6, the phase shifter 1 includes a phase shift assembly 10, and the phase shift assembly 10 includes a substrate 11 and a rotating arm 13. Specifically, an output line 111 is disposed on the substrate 11. The output line 111 may also be referred to as a strip, and the output line 111 and the substrate 11 jointly form a main printed circuit board (PCB). The output line 111 includes an arc-shaped segment 1111, a first output segment 1112, and a second output segment 1113. For ease of description, one end of the arc-shaped segment 1111 is a first end, and the other end is a second end. The first output segment 1112 is electrically connected to the first end of the arc-shaped segment 1111, and the second output segment 1113 is electrically connected to the second end of the arc-shaped segment 1111. In a specific embodiment, the arc-shaped segment 1111, the first output segment 1112, and the second output segment 1113 may be an integrated structure.

The rotating arm 13 is connected to the substrate 11, and can rotate relative to the substrate 11. A specific connection manner of the rotating arm 13 and the substrate 11 is not limited. For example, in a specific embodiment, a rotating shaft 12 is disposed on the substrate 11, and the rotating shaft 12 can rotate relative to the substrate 11 under the action of an external force. Specifically, a rotating shaft mounting hole 112 may be disposed in the substrate 11, and the rotating shaft 12 is inserted into the rotating shaft mounting hole 112 and can rotate relative to the rotating shaft mounting hole 112. In another specific embodiment, a bearing mounting hole is disposed in the substrate 11, a bearing is mounted in the rotating shaft mounting hole 112, and the rotating shaft 12 is inserted into an inner hole of the bearing and is in interference fitting with the inner hole of the bearing. The rotating arm 13 is fastened to the rotating shaft 12.

When fastening between the rotating arm 13 and the rotating shaft 12 is specifically implemented, the rotating shaft 12 and the rotating arm 13 may be an integrally formed structure, or fastened in another form. For example, a hole 131 is disposed in the rotating arm 13, and the rotating shaft 12 is inserted into the hole 131 and is in interference fitting with the hole 131; or a hole 131 is disposed in the rotating arm 13, the rotating shaft 12 is inserted into the hole 131, a limiting protrusion is disposed on one of the hole 131 and the rotating shaft 12, a limiting groove matching the limiting protrusion is disposed on the other, and the limiting protrusion is inserted into the limiting groove, to implement fastening between the rotating arm 13 and the rotating shaft 12.

When the rotating shaft 12 is specifically disposed, a material of the rotating shaft 12 is not limited, and the rotating shaft 12 may be an insulated rotating shaft, for example, a plastic rotating shaft. A coupling line 132 is disposed on the rotating arm 13, and the coupling line 132 and the rotating arm 13 jointly form a coupling PCB. The coupling line 132 is connected to a coupling part 114 through coupling, and is also connected to the arc-shaped segment 1111 of the output line 111 through coupling. This is specifically described below. The rotating shaft 12 passing through the substrate 11 and the rotating arm 13 is an insulated rotating shaft, to help avoid a short circuit between the coupling part 114 and the coupling line 132. Certainly, in another optional embodiment, the rotating shaft 12 may alternatively be a metal rotating shaft. In this case, it is only necessary to take an effective measure to avoid a short circuit. For example, at least one of the rotating arm 13 and the substrate 11 may be insulated from the rotating shaft 12.

Still refer to FIG. 6. In a specific embodiment, a main feeder 113 and the coupling part 114 are disposed on the substrate 11, and the main feeder 113 is electrically connected to the coupling part 114. The coupling line 132 is disposed on the rotating arm 13, one end of the coupling line 132 is electrically connected to the arc-shaped segment 1111 of the output line 111, and the other end of the coupling line 132 is electrically connected to the coupling part 114, to implement an electrical connection between the arc-shaped segment 1111 and the main feeder 113.

In a specific embodiment, the coupling line 132 is connected to the arc-shaped segment 1111 of the output line 111 through coupling, and a first preset gap exists between the coupling line 132 and the arc-shaped segment 1111 of the output line 111. The coupling line 132 is also connected to the coupling part 114 through coupling, and a second preset gap exists between the coupling line 132 and the coupling part 114. A size of the first preset gap may be the same as or different from a size of the second preset gap. It is worth noting that the coupled connection may also be referred to as capacitive coupling. When two connection objects are connected through coupling, a signal can be transmitted between the two connection objects.

For example, a first insulation layer may be disposed between the coupling line 132 and the output line 111, so that the first preset gap is formed between the coupling line 132 and the arc-shaped segment 1111. Specifically, the first insulation layer may be disposed on the coupling line 132, the first insulation layer may be disposed on the output line 111, or the first insulation layer may be disposed on both the coupling line 132 and the output line 111. A second insulation layer is disposed between the coupling line 132 and the coupling part 114, so that the second preset gap is formed between the coupling line 132 and the coupling part 114. Specifically, the second insulation layer may be disposed on the coupling line 132, the second insulation layer may be disposed on the coupling part 114, or the second insulation layer may be disposed on both the coupling line 132 and the coupling part 114.

Still refer to FIG. 5. The phase shift assembly 10 further includes a drive arm 15 and a drive assembly 14. One end of the drive arm 15 is fastened to the rotating arm 13, and the other end extends to a side that is of the rotating shaft 12 and that faces away from the output line 111, and is in transmission connection to the drive assembly 14. That the drive arm 15 is in transmission connection to the drive assembly 14 may be understood as follows: The drive arm 15 is connected to the drive assembly 14, and the drive assembly 14 can drive the drive arm 15 to move. Specifically, the drive assembly 14 can drive the drive arm 15 to swing, so that the drive arm 15 drives the rotating arm 13 to swing relative to the substrate 11. In a process in which the rotating arm 13 swings relative to the substrate 11, the coupling line 132 slides along the arc-shaped segment 1111 of the output line 111, to implement a phase shift.

In the foregoing solution, in the phase shifter 1 of the antenna, the phase shift assembly 10 includes the drive arm 15, the drive arm 15 extends to the side that is of the rotating shaft 12 and that faces away from the output line 111, and the drive assembly 14 drives, through the drive arm 15, the rotating arm 13 to rotate, to implement a phase shift. A force arm acting on the rotating shaft 12 is extended because the drive arm 15 is disposed. Compared with a related technology, only a smaller force is required to drive the rotating arm 13 to rotate. This can reduce a requirement for power performance of the drive assembly 14, reduce design complexity of the phase shifter 1, and reduce energy consumption and costs; and can also effectively alleviate a problem that the drive assembly has a relatively large transmission weight and a failure rate of vibration joint adjustment is relatively high due to excessively large transmission resistance of the phase shifter 1.

When the fastened connection between the drive arm 15 and the rotating arm 13 is specifically implemented, a specific connection manner of the drive arm 15 and the rotating arm 13 is not limited, provided that the fastened connection between the drive arm 15 and the rotating arm 13 can be implemented.

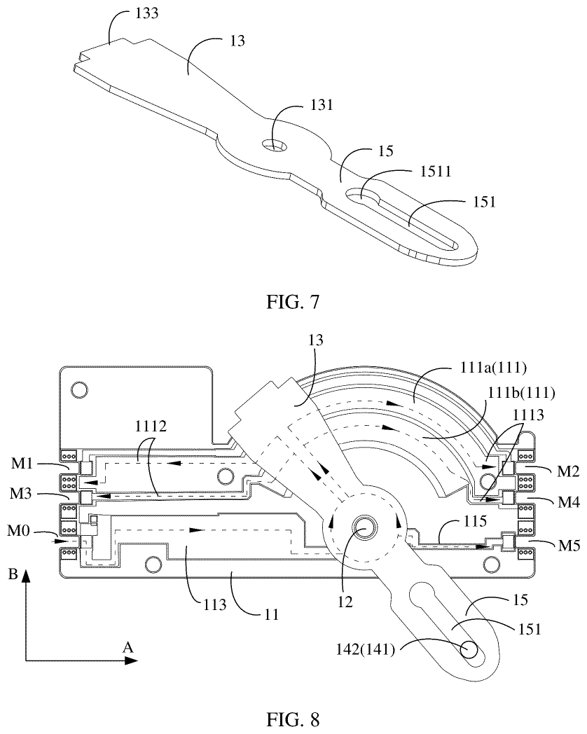

FIG. 7 is a diagram of a structure of a rotating arm and a drive arm according to an embodiment of this application. As shown in FIG. 7, in an optional embodiment, the rotating arm 13 and the drive arm 15 are an integrated structure. The rotating arm 13 and the drive arm 15 use an integrated structure, so that connection strength of the rotating arm 13 and the drive arm 15 can be improved, and an assembly process of the rotating arm 13 and the drive arm 15 can be further omitted, to help reduce an assembly error, thereby improving precision of the phase shifter 1.

Certainly, the rotating arm 13 and the drive arm 15 may alternatively be a split structure, in other words, both the rotating arm 13 and the drive arm 15 are independent components. In this case, the rotating arm 13 may be fastened to the drive arm 15 in a welding manner, a riveting manner, a bolt connection manner, or the like.

When the substrate 11 is specifically disposed, a quantity of output lines 111 may be set based on an actual requirement. For example, one output line 111 may be disposed, or two output lines 111 may be disposed on the substrate 11. The following describes a working principle of the phase shifter 1 by using an example in which two output lines 111 are disposed on the substrate 11.

For ease of description, in the two output lines 111, one output line 111 far away from the rotating shaft 12 is denoted as a first output line 111a, and the other output line 111 is denoted as a second output line 111b. The first output line 111a and the second output line 111b each include an arc-shaped segment 1111, a first output segment 1112, and a second output segment 1113, circle centers of arc-shaped segments 1111 of the two output lines 111 coincide, and both the arc-shaped segments 1111 are electrically connected to the coupling line 132.

FIG. 8 is a diagram of a working principle of a phase shifter according to an embodiment of this application. Specifically, as shown in FIG. 8, a first output segment 1112 of the first output line 111a is configured to output a first signal, and an end that is of the first output segment 1112 and that is far away from an arc-shaped segment 1111 may be denoted as a first signal output end M1. A second output segment 1113 of the first output line 111a is configured to output a second signal, and an end that is of the second output segment 1113 and that is far away from the arc-shaped segment 1111 may be denoted as a second signal output end M2. A first output segment 1112 of the second output line 111b is configured to output a third signal, and an end that is of the first output segment 1112 and that is far away from an arc-shaped segment 1111 may be denoted as a third signal output end M3. A second output segment 1113 of the second output line 111b is configured to output a fourth signal, and an end that is of the second output segment 1113 and that is far away from the arc-shaped segment 1111 may be denoted as a fourth signal output end M4.

One end of the main feeder 113 is electrically connected to the coupling part 114, and the other end of the main feeder 113 is a signal input end M0. The signal input end is configured to receive an electrical signal input to the phase shifter 1, and the electrical signal may be denoted as an input electrical signal.

During working, the input electrical signal enters from the signal input end of the main feeder 113, is transferred to the two output lines 111 through the main feeder 113, the coupling part 114, and the coupling line 132, and is divided into two signals, namely, left and right signals, from an electrical connection place between the coupling line 132 and each output line 111. In the first output line 111a, one electrical signal passes through a partial output line 111 between the first signal output end M1 and the coupling line 132 and is output from the first signal output end M1, and the other electrical signal passes through a partial output line 111 between the second signal output end M2 and the coupling line 132 and is output from the second signal output end M2. In the second output line 111b, one electrical signal passes through a partial output line 111 between the third signal output end M3 and the coupling line 132 and is output from the third signal output end M3, and the other electrical signal passes through a partial output line 111 between the fourth signal output end M4 and the coupling line 132 and is output from the fourth signal output end M4. The coupling line 132 is coupled to the first output line 111a and the second output line 111b in a process of swinging left and right, to implement a change of a physical length of the output line 111, to implement a change of a phase of each signal output end and implement a phase shift.

In a specific embodiment, the phase shifter 1 uses a disc phase shift structure, and implements a phase shift function based on a strip physical phase shift scenario by controlling a relative position of the coupling line 132 to the output line 111.

Still refer to FIG. 5. When the drive assembly 14 is specifically disposed, the drive assembly 14 includes a power output end 141, and the power output end 141 is in transmission connection to the drive arm 15. In an embodiment, the drive assembly 14 drives the power output end 141 to reciprocate along a first direction A, and the power output end 141 drives the drive arm 15 to swing, to drive the rotating arm 13 to rotate, to implement a phase shift. For example, the drive assembly 14 may be a metal structure, or may be a non-metal structure. This is not limited in this embodiment of this application.

In an optional technical solution, the first direction A is in a same plane as a symmetry axis of the arc-shaped segment 1111, and is perpendicular to the symmetry axis of the arc-shaped segment 1111.

Usually, an edge of an end that is of the substrate 11 and that is far away from the output line 111 is a straight line, so that the direction in which the power output end 141 reciprocates is perpendicular to the symmetry axis of the arc-shaped segment 1111, in other words, a movement direction of the power output end 141 is parallel to the edge of the substrate 11, so that a movement path of the power output end 141 is shorter. This helps reduce design difficulty of a structure of the arc-shaped segment 1111, a movement speed of the power output end 141, and the like, and also helps reduce a size occupied by the phase shifter 1 in a direction of the symmetry axis of the arc-shaped segment 1111, thereby facilitating miniaturization and a lightweight property of the phase shifter 1.

It is worth noting that, in this embodiment of this application, “perpendicular” is described for a current process level, but is not an absolute strict definition in a mathematical sense. A deviation of a predetermined angle may exist between the first direction A and the symmetry axis of the arc-shaped segment 1111. In other words, an included angle between the first direction and the symmetry axis of the arc-shaped segment 1111 is not necessarily strict 90°, and may be 85°, 86°, 87°, 88°, 89°, 91°, 92°, 93°, 94°, 95°, or the like. In this embodiment of this application, “parallel” is described for a current process level, but is not an absolute strict definition in a mathematical sense. A deviation of a predetermined angle may exist between the movement direction of the power output end 141 and the edge of the substrate 11. In other words, an included angle between the movement direction of the power output end 141 and the edge of the substrate 11 is not necessarily strict 0° or 180°. For example, an included acute angle between the movement direction of the power output end 141 and the edge of the substrate 11 may be 0.5°, 1°, 1.5°, 2°, 3°, 4°, 4.5°, 5°, or the like.

In an embodiment, the rotating shaft 12 is located on the symmetry axis of the arc-shaped segment 1111, so that a movement track of the rotating arm 13 is symmetrical about the symmetry axis of the arc-shaped segment 1111, and structural designs of the drive assembly 14 and the output line 111 are more simplified.

In another embodiment, the rotating shaft 12 may alternatively be located outside the symmetry axis of the arc-shaped segment 1111, and details are not described in this implementation.

When the main feeder 113 and the coupling part 114 are specifically disposed on the substrate 11, in an embodiment, both the main feeder 113 and the coupling part 114 are located on a side that is of the output line 111 and that faces the rotating shaft, and an extension direction of the main feeder 113 is parallel to the first direction A.

An included angle between the extension direction of the main feeder 113 and the first direction A is 0°, so that a size occupied by the main feeder 113 in a second direction B is smaller, to help reduce a size of the phase shift assembly 10 in the second direction B, and facilitate miniaturization and a lightweight property of the phase shifter 1. Both the second direction B and the first direction A are in a plane in which the substrate 11 is located, and the second direction B is perpendicular to the first direction A.

For example, the coupling part 114 may be in a ring shape, and the rotating shaft 12 passes through a ring hole in the ring shape.

Still refer to FIG. 8. Further, the phase shifter 1 may further include a third output line 115 disposed on the substrate 11. The third output line 115 is located on the side that is of the output line 111 and that faces the rotating shaft 12, and is electrically connected to the coupling part 114. An end that is of the third output line 115 and that is far away from the coupling part 114 may be denoted as a fifth output end M5, and the fifth output end M5 is configured to transmit an electrical signal, so that a quantity of signals transmitted by the antenna can be increased.

In a specific embodiment, an extension direction of the third output line 115 is parallel to the first direction A, so that a size occupied by the third output line 115 in the second direction B is smaller, to help reduce a size of the phase shift assembly 10 in the second direction B, and facilitate miniaturization and a lightweight property of the phase shifter 1.

When the third output line 115 is specifically disposed, in an embodiment, the third output line 115 and the main feeder 113 may be located on a same side of the coupling part 114 in the first direction A. In another embodiment, the third output line 115 and the main feeder 113 may alternatively be located on different sides of the coupling part 114 in the first direction. For example, the main feeder 113, the coupling part 114, and the third output line 115 may be sequentially disposed along the first direction A.

When the arc-shaped segment 1111 of the output line 111 is specifically disposed, the arc-shaped segment 1111 may be a smooth arc-shaped line, or may include several V-shaped, “s”-shaped, “∩”-shaped, “Ω”-shaped, “M”-shaped, or “W”-shaped substructures connected end to end, where the substructures are connected in an arc-shaped direction.

Still refer to FIG. 8. In an embodiment, a guide trough 151 is disposed on the drive arm 15, and the guide trough 151 extends along a length direction of the drive arm 15. The power output end 141 includes a push shaft 142, and the push shaft 142 is inserted into the guide trough 151, and can be driven by the drive assembly 14 to slide relative to the guide trough 151. In this solution, the guide trough 151 can be disposed to guide and limit movement of the push shaft 142, to ensure a movement path of the rotating arm 13, and ensure reliable contact between the coupling line 132 and the arc-shaped segment 1111 of the output line 111, thereby ensuring phase shift reliability.

It is worth noting that, in this embodiment of this application, a length direction of an object X may be understood as follows: The object X extends along approximately two directions in a plane in which the object X is located: a third direction and a fourth direction, where the third direction and the fourth direction are perpendicular to each other. A size of the object X in the third direction is C, and a size of the object X in the fourth direction is D. If C>D, the third direction is the length direction of the object X, and the fourth direction is a width direction of the object X.

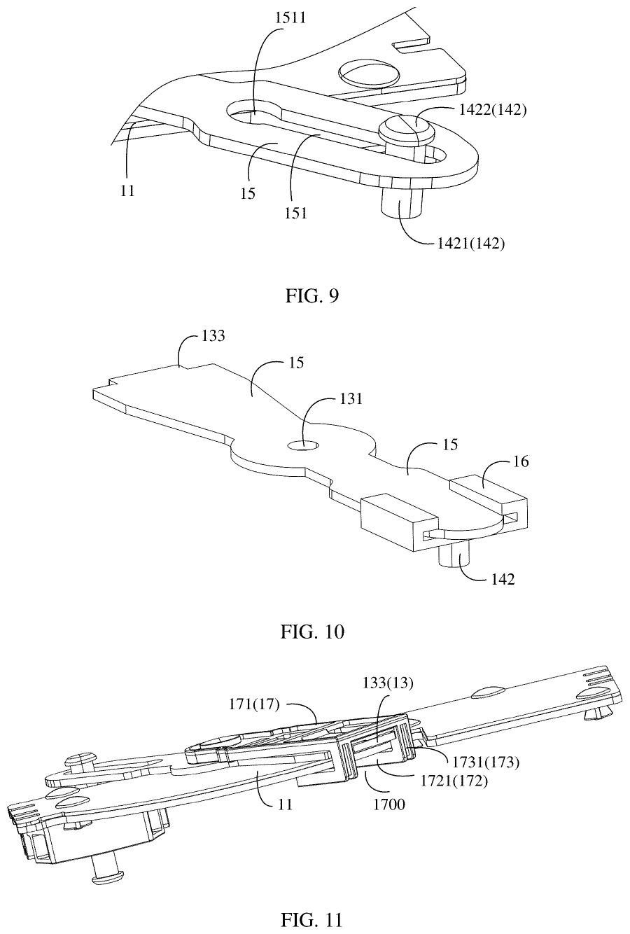

FIG. 9 is a diagram of a connection relationship between a push shaft and a drive arm according to an embodiment of this application. As shown in FIG. 9, when the push shaft 142 is specifically disposed, the push shaft 142 may include a shaft body 1421 and a stopper 1422, and an axial direction of the shaft body 1421 is parallel to an axial direction of the rotating shaft 12. Specifically, the drive assembly 14 includes a power part, and the power part is in transmission connection to the push shaft 142, to drive the push shaft 142 to move along the first direction A. One end of the shaft body 1421 is in transmission connection to the power part, and the other end is fastened to the stopper 1422 after passing through the guide trough 151.

When the push shaft 142 is specifically disposed, a diameter of the shaft body 1421 is slightly less than a width of the guide trough 151, so that the shaft body 1421 is in clearance fitting with the guide trough 151. An outline size of the stopper 1422 is greater than the width of the guide trough 151, to implement axial limiting of the shaft body 1421.

Further, in an optional embodiment, the stopper 1422 and the shaft body 1421 are an integrated structure, so that a connection between the stopper 1422 and the shaft body 1421 is more reliable. Correspondingly, in this case, an avoiding hole 1511 of the stopper 1422 is disposed at an end that is of the guide trough 151 and that is close to the rotating shaft 12, so that the stopper 1422 can pass through the avoiding hole 1511, and the shaft body 1421 can slide in the guide trough 151, so that the stopper 1422 plays an axial limiting role for the shaft body 1421.

Certainly, a connection manner of the stopper 1422 and the shaft body 1421 is not limited to the integrated structure. For example, both the stopper 1422 and the shaft body 1421 may alternatively be independent components, and the two components are fastened. Further, the two components may be disassembled.

A specific structure of the stopper 1422 is not limited, and an outline of the avoiding hole 1511 in the guide trough 151 may match an outline of the stopper 1422. For example, in an embodiment, the stopper 1422 is plate-shaped. Specifically, the stopper 1422 may be circular plate-shaped, square plate-shaped, or the like. In another embodiment, the stopper 1422 may be rod-shaped or block-shaped.

FIG. 10 is a diagram of another connection relationship between a push shaft and a drive arm according to an embodiment of this application. As shown in FIG. 10, when the connection between the drive arm 15 and the power output end 141 is specifically implemented, in another embodiment, the phase shift assembly 10 may include a sliding sleeve 16, and the sliding sleeve 16 is sleeved onto the drive arm 15, and can slide relative to the drive arm 15 along a length direction of the drive arm 15. An insertion hole is disposed in the sliding sleeve 16, and an axial direction of the insertion hole is parallel to an axial direction of the rotating shaft 12. A push shaft 142 is inserted into the insertion hole, and can rotate relative to the insertion hole.

FIG. 11 is a diagram of a partial structure of a phase shifter according to an embodiment of this application. As shown in FIG. 11, in a specific embodiment, the phase shift assembly 10 may include an elastic crimping assembly 17. The elastic crimping assembly 17 is fastened to the rotating arm 13, and clamps the substrate 11 and the rotating arm 13, to apply an abutting force toward the substrate 11 to the rotating arm 13, so that all gaps between the coupling line 132 and the arc-shaped segment 1111 of the output line 111 are o, thereby implementing reliable contact between the coupling line 132 and the arc-shaped segment 1111 of the output line 111, and maintaining a stable coupled connection relationship between the coupling line 132 and the output line 111.

Uniformity of the gaps between the coupling line 132 and the arc-shaped segment 1111 of the output line 111 has relatively large impact on standing wave consistency of the antenna. Smaller and more uniform gaps indicate better standing wave consistency of the antenna. In this embodiment, the elastic crimping assembly 17 applies the abutting force toward the substrate 11 to the rotating arm 13, so that all the gaps between the coupling line 132 and the arc-shaped segment 1111 of the output line 111 are 0, and all the gaps between the coupling line 132 and the arc-shaped segment 1111 of the output line 111 are 0. This meets a “small” gap requirement, and also achieves better uniformity. In this way, feeding performance, consistency, and stability of the phase shifter 1 provided in this embodiment are more stable, and standing wave consistency of the antenna is better. In addition, the rotating arm 13 can ensure a proper push-pull force.

It should be noted that the elastic crimping assembly 17 has relatively small impact on a push-pull force of the phase shifter 1, and has relatively small impact on a transmission weight pressure of the phase shifter 1.

In a specific embodiment, to avoid a short circuit, the elastic crimping assembly 17 may have an insulation property. For example, the elastic crimping assembly 17 may be an elastic plastic member, another insulated elastic non-metal member, or an elastic metal member on which an insulation layer is disposed. In an optional embodiment, the elastic crimping assembly 17 is an elastic plastic member formed through integral injection molding, to achieve a better crimping effect while avoiding a short circuit.

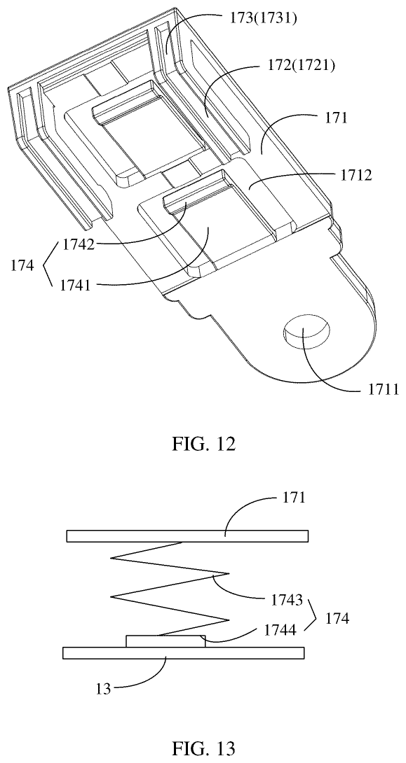

FIG. 12 is a diagram of a structure of an elastic crimping assembly according to an embodiment of this application. As shown in FIG. 11 and FIG. 12, in a specific embodiment, the elastic crimping assembly 17 may include a crimping body 171, a crimping foot group 172, and a transition connecting part 173. The crimping foot group 172 is located on a side that is of the substrate 11 and that faces away from the rotating arm 13, and abuts against and is slidably connected to a surface that is of the substrate 11 and that faces away from the rotating arm 13. The crimping body 171 is fastened to a side that is of the rotating arm 13 and that faces away from the substrate 11, and an elastic crimping part 174 configured to press the rotating arm 13 toward the substrate 11 is disposed. The transition connecting part 173 connects the crimping body 171 and the crimping foot group 172, so that the crimping body 171 and the crimping foot group 172 can jointly act to clamp the substrate 11 and the rotating arm 13.

In an embodiment, the substrate 11 may have an arc-shaped edge, and the arc-shaped edge is located on a side that is of the output line 111 and that faces away from the rotating shaft 12. The elastic crimping assembly 17 slidably fits with the arc-shaped edge. In a specific embodiment, a circle center of the arc-shaped edge coincides with a circle center of the arc-shaped segment 1111 of the output line 111, to play a guiding role for movement of the rotating arm 13 through fitting between the elastic crimping assembly 17 and the arc-shaped edge, so that contact between the coupling line 132 and the arc-shaped segment 1111 is more reliable.

The crimping foot group 172 includes at least two crimping feet 1721, the transition connecting part 173 includes at least two connecting arms 1731, and the crimping feet 1721 are spaced apart along an extension direction of the arc-shaped edge. The connecting arms 1731 are connected to the crimping feet 1721 in one-to-one correspondence, and space between two adjacent connecting arms 1731 forms a slot 1700. An insertion block 133 adapted to the slot 1700 is disposed at an end that is of the rotating arm 13 and that is close to the arc-shaped edge, and the insertion block 133 is inserted into the slot 1700, to implement an end connection between the rotating arm 13 and the elastic crimping assembly 17. In a process in which the rotating arm 13 swings, the insertion block 133 and the slot 1700 form a tangential force, so that the rotating arm 13 drives the elastic crimping assembly 17 to synchronously move. In addition, fitting between the slot 1700 and the insertion block 133 also facilitates quick positioning between the elastic crimping assembly 17 and the rotating arm 13.

In this embodiment, a correspondence between the insertion block 133 and the slot 1700 is not limited. For example, insertion blocks 133 may be in one-to-one correspondence with slots 1700, and each insertion block 133 is inserted into a corresponding slot 1700. Alternatively, a quantity of insertion blocks 133 may be less than a quantity of slots 1700, but each insertion block 133 matches a slot 1700.

In an optional embodiment, the crimping foot group 172 includes two crimping feet 1721 spaced apart along the extension direction of the arc-shaped edge, and space between the two crimping feet 1721 forms a slot 1700. An insertion block 133 is disposed at the end that is of the rotating arm 13 and that is close to the arc-shaped edge, and the insertion block 133 is inserted into the slot 1700. In this solution, the crimping foot group 172 includes only two crimping feet 1721, so that the elastic crimping assembly 17 has a simpler structure and a smaller size, thereby facilitating miniaturization and a lightweight property of the phase shifter 1.

To make the connection between the elastic crimping assembly 17 and the rotating arm 13 more reliable, in an embodiment, the crimping body 171 is fastened to the rotating shaft 12. For example, a through hole 1711 is disposed at an end that is of the crimping body 171 and that is close to the rotating shaft 12, and the rotating shaft 12 is in interference fitting with the through hole 1711, or the end that is of the crimping body 171 and that is close to the rotating shaft 12 is welded onto the rotating shaft 12.

As shown in FIG. 12, when the elastic crimping part 174 is specifically disposed, in an optional embodiment, a hollow area 1712 may be formed on the crimping body 171, the elastic crimping part 174 includes a spring plate, and the spring plate is disposed in the hollow area 1712. In this solution, the elastic crimping part 174 has a relatively small quantity of components, so that crimping is more accurate and reliable. In addition, a structure of the elastic crimping assembly 17 can also be simplified.

In this embodiment, a shape of the hollow area 1712, a connection position of the spring plate in the hollow area 1712, and a quantity of spring plates are not limited, provided that the spring plate can apply an abutting force to the rotating arm 13 to press the rotating arm 13 toward the substrate 11. For example, the hollow area 1712 may be circular, elliptical, rectangular, or the like, and there may be one spring plate, two spring plates, three spring plates, or the like in the hollow area 1712.

For example, the hollow area 1712 is rectangular. When one spring plate is disposed in the hollow area 1712, the spring plate may be disposed on any side of the hollow area 1712. When a plurality of spring plates are disposed in the hollow area 1712, positions of the spring plates in the hollow area 1712 may be set based on an actual requirement. For example, the plurality of spring plates may be evenly distributed in the hollow area 1712, so that the rotating arm 13 is more evenly stressed. It is worth noting that, “a plurality of” mentioned in this embodiment means “greater than or equal to 2”.

In addition, in this embodiment, a quantity of hollow areas 1712 on the crimping body 171 is not limited. For example, one hollow area 1712, two hollow areas 1712, or three hollow areas 1712 may be disposed on the crimping body 171. When the quantity of hollow areas 1712 on the crimping body 171 is greater than or equal to 2, an arrangement of hollow areas 1712 on the crimping body 171 may be set based on an actual requirement.

In a specific embodiment, a quantity of hollow areas 1712 on the crimping body 171 is the same as a quantity of output lines 111 disposed on the substrate 11, and each output line 111 is opposite to a spring plate in one hollow area 1712. For example, when two output lines 111, namely, the first output line 111a and the second output line 111b, are disposed on the substrate 11, two hollow areas 1712 are disposed on the crimping body 171, the two hollow areas 1712 are arranged along a length direction of the crimping body 171, at least one spring plate is disposed in each hollow area 1712, and each spring plate is connected to an end that is of a corresponding hollow area 1712 and that is close to the rotating shaft 12. In addition, each spring plate in one hollow area 1712 is opposite to the arc-shaped segment 1111 of the first output line 111a, and each spring plate in the other hollow area 1712 is opposite to the arc-shaped segment 1111 of the second output line 111b.

In this embodiment, a quantity of elastic crimping assemblies 17 is not limited. For example, there may be one elastic crimping assembly 17, two elastic crimping assemblies 17, or three elastic crimping assemblies 17. When the quantity of elastic crimping assemblies 17 is greater than or equal to 2, each elastic crimping assembly 17 is fastened to the rotating arm 13, to synchronously rotate with the rotating arm 13, and always press the rotating arm 13 toward the substrate 11.

A specific shape of the spring plate is not limited. For example, the spring plate may be a rectangular, trapezoidal, or circular planar structure, and may further include a spring plate body 1741 and a crimping protrusion 1742. The spring plate body 1741 is a rectangular, trapezoidal, or circular planar structure, and the crimping protrusion 1742 is disposed on the spring plate body 1741 and is located on a side that is of the spring plate body 1741 and that faces the rotating arm 13.

FIG. 13 is a diagram of a structure of an elastic crimping assembly, a rotating arm, and a substrate according to an embodiment of this application. As shown in FIG. 13, in another embodiment, the elastic crimping part 174 may alternatively use another structure. For example, the elastic crimping part 174 may include an elastic member 1743 and a crimping member 1744. The crimping member 1744 is located between the crimping body 171 and the rotating arm 13, the elastic member 1743 is located between the crimping body 171 and the crimping member 1744, and one end of the elastic member 1743 is connected to the crimping body 171, and the other end is connected to the crimping member 1744. For example, the elastic member 1743 may be a spring, and the crimping member 1744 may be a crimping plate.

In a specific embodiment, the phase shifter 1 may include one phase shift assembly 10, or may include a plurality of phase shift assemblies 10. When the phase shifter 1 includes a plurality of phase shift assemblies 10, the plurality of phase shift assemblies 10 are sequentially disposed along the axial direction of the rotating shaft 12, in other words, the phase shift assemblies 10 are stacked along the axial direction of the rotating shaft 12. Stacking the phase shift assemblies 10 helps reduce a volume of the phase shifter 1.

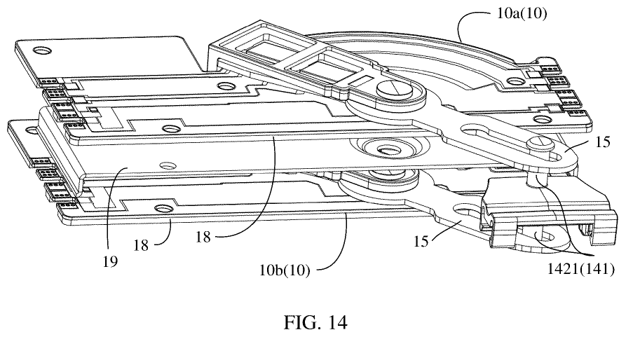

FIG. 14 is a diagram of a structure of a phase shifter according to another possible embodiment of this application. As shown in FIG. 14, in an optional embodiment, the phase shifter 1 includes a plurality of phase shift assemblies 10, and at least one phase shift assembly 10 and a phase shift assembly 10 adjacent to the at least one phase shift assembly 10 share one drive assembly 14. Therefore, a quantity of components can be reduced. This facilitates miniaturization and a lightweight property of the phase shifter 1, and can also reduce costs.

Specifically, the drive assembly 14 may include the power part and two power output ends 141. The two power output ends 141 are sequentially disposed along the axial direction of the rotating shaft 12, and are both in transmission connection to the power part. Two adjacent phase shift assemblies 10 are respectively a first phase shift assembly 10a and a second phase shift assembly 10b. One of the two power output ends 141 is in transmission connection to a drive arm 15 of the first phase shift assembly 10a, and the other of the two power output ends 141 is in transmission connection to a drive arm 15 of the second phase shift assembly 10b.

Further, still refer to FIG. 14. The phase shift assembly 10 may include a shielding panel 18, to improve structural strength of the phase shift assembly 10. Specifically, the substrate 11 is fastened to the shielding panel 18, and the rotating arm 13 is located on a side that is of the substrate 11 and that faces away from the shielding panel 18. When the phase shifter 1 includes a plurality of phase shift assemblies 10, the shielding panel 18 can support a corresponding substrate 11 to enhance structural strength of the phase shifter 1, and can also reduce or even shield signal interference between two adjacent phase shift assemblies 10. For example, the shielding panel 18 may be a metal partition plate or a dielectric plate on which a metal layer is formed.

In addition, the phase shifter 1 provided in this embodiment shields signal interference between two adjacent phase shift assemblies 10 through the shielding panel 18. Compared with a related technology in which a support plate and a cover plate are disposed for each phase shift assembly 10 to form a separate cavity, a thickness of the phase shifter 1 can be reduced, and a weight of the entire phase shifter 1 can be greatly reduced.

In a possible embodiment, when the phase shifter 1 includes one phase shift assembly 10, a metal housing 19 may be disposed on a side that is of a rotating arm 13 and that faces away from a substrate 11, to shield external signal interference, and improve an electrical indicator of the phase shifter. When the phase shifter 1 includes a plurality of phase shift assemblies 10 sequentially disposed along the axial direction of the rotating shaft 12, a metal housing 19 may be disposed between two adjacent phase shift assemblies 10, to shield signal interference between the two adjacent phase shift assemblies 10, and improve an electrical performance indicator of the phase shifter.

Specifically, when the phase shifter 1 is disposed in a radome, a mounting clip may be fastened to the radome. The mounting clip includes a clamping part. Clamping parts are connected to phase shift assemblies 10 in one-to-one correspondence, to fasten the phase shift assemblies 10 to the radome.

It is clear that a person skilled in the art can make various modifications and variations to this application without departing from the protection scope of this application. In this way, this application is also intended to cover these modifications and variations to this application provided that they fall within the scope of the claims of this application and equivalent technologies thereof.

What is claimed is:

1. A phase shifter, comprising a phase shift assembly, wherein the phase shift assembly comprises a substrate, a rotating arm, a drive arm, and a drive assembly, wherein an output line is disposed on the substrate, and the output line comprises an arc-shaped segment; and the rotating arm is rotatably connected to the substrate through a rotating shaft, a coupling line is disposed on the rotating arm, and the coupling line is electrically connected to the arc-shaped segment; and
one end of the drive arm is fastened to the rotating arm, and the other end extends to a side that is of the rotating shaft and that faces away from the output line, and is in transmission connection to the drive assembly; the drive assembly drives the drive arm to move, and the drive arm drives the rotating arm to rotate relative to the substrate; and in a process in which the rotating arm rotates relative to the substrate, the coupling line slides along the arc-shaped segment.

2. The phase shifter according to claim 1, wherein the rotating arm and the drive arm are an integrated structure.

3. The phase shifter according to claim 1, wherein the drive assembly comprises a power output end, the power output end is in transmission connection to the drive arm, the drive assembly drives the power output end to reciprocate along a first direction, and the power output end drives the drive arm to drive the rotating arm to rotate.

4. The phase shifter according to claim 3, wherein the first direction is in a same plane as a symmetry axis of the arc-shaped segment, and is perpendicular to the symmetry axis of the arc-shaped segment.

5. The phase shifter according to claim 1, wherein the rotating shaft is located on the symmetry axis of the arc-shaped segment.

6. The phase shifter according to claim 3, wherein a guide trough is disposed on the drive arm, and the guide trough extends along a length direction of the drive arm; and the power output end comprises a push shaft, and the push shaft is inserted into the guide trough, and is driven by the drive assembly to slide relative to the guide trough.

7. The phase shifter according to claim 1, wherein the phase shift assembly comprises an elastic crimping assembly, and the elastic crimping assembly is fastened to the rotating arm, and clamps the substrate and the rotating arm, to apply an abutting force toward the substrate to the rotating arm.

8. The phase shifter according to claim 7, wherein the elastic crimping assembly comprises a crimping body, a crimping foot group, and a transition connecting part, wherein the crimping foot group is located on a side that is of the substrate and that faces away from the rotating arm, and abuts against and is slidably connected to a surface that is of the substrate and that faces away from the rotating arm; the crimping body is fastened to a side that is of the rotating arm and that faces away from the substrate, and an elastic crimping part configured to press the rotating arm toward the substrate is disposed; and the transition connecting part connects the crimping body and the crimping foot group.

9. The phase shifter according to claim 8, wherein the substrate has an arc-shaped edge, and the arc-shaped edge is located on a side that is of the output line and that faces away from the rotating shaft; and the elastic crimping assembly slidably fits with the arc-shaped edge;
the crimping foot group comprises at least two crimping feet, the transition connecting part comprises at least two connecting arms, and the crimping feet are spaced apart along an extension direction of the arc-shaped edge; the at least two connecting arms are connected to the at least two crimping feet in one-to-one correspondence; and space between two adjacent connecting arms forms a slot; and
an insertion block adapted to the slot is disposed at an end that is of the rotating arm and that is close to the arc-shaped edge, and the insertion block is inserted into the slot.

10. The phase shifter according to claim 8, wherein a hollow area is formed on the crimping body, and the elastic crimping part comprises a spring plate disposed in the hollow area.

11. The phase shifter according to claim 1, wherein two output lines are disposed on the substrate, the two output lines are respectively a first output line and a second output line, a circle center of an arc-shaped segment of the first output line coincides with a circle center of an arc-shaped segment of the second output line, the first output line is farther away from the rotating shaft than the second output line, and both the arc-shaped segment of the first output line and the arc-shaped segment of the second output line are electrically connected to the coupling line.

12. The phase shifter according to claim 1, comprising a main feeder and a coupling part that are disposed on the substrate, wherein both the main feeder and the coupling part are located on a side that is of the output line and that faces the rotating shaft, the main feeder is electrically connected to the coupling part, and an extension direction of the main feeder is parallel to the first direction.

13. The phase shifter according to claim 12, comprising a third output line disposed on the substrate, wherein the third output line is located on the side that is of the output line and that faces the rotating shaft, and is electrically connected to the coupling part; and an extension direction of the third output line is parallel to the first direction.

14. The phase shifter according to claim 1, wherein there are a plurality of phase shift assemblies, and the plurality of phase shift assemblies are sequentially disposed along an axial direction of the rotating shaft.

15. The phase shifter according to claim 14, wherein the phase shift assembly comprises a shielding panel, the substrate is fastened to the shielding panel, and the rotating arm is located on a side that is of the substrate and that faces away from the shielding panel.

16. An antenna, comprising a radiating element and a phase shifter, wherein the radiating element is electrically connected to the phase shifter, and the phase shifter is configured to adjust a feeding phase of the radiating element;
wherein the phase shifter comprises a phase shift assembly, wherein the phase shift assembly comprises a substrate, a rotating arm, a drive arm, and a drive assembly, wherein an output line is disposed on the substrate, and the output line comprises an arc-shaped segment; and the rotating arm is rotatably connected to the substrate through a rotating shaft, a coupling line is disposed on the rotating arm, and the coupling line is electrically connected to the arc-shaped segment; and
one end of the drive arm is fastened to the rotating arm, and the other end extends to a side that is of the rotating shaft and that faces away from the output line, and is in transmission connection to the drive assembly; the drive assembly drives the drive arm to move, and the drive arm drives the rotating arm to rotate relative to the substrate; and in a process in which the rotating arm rotates relative to the substrate, the coupling line slides along the arc-shaped segment.

17. The phase shifter according to claim 16, wherein the rotating arm and the drive arm are an integrated structure.

18. The phase shifter according to claim 16, wherein the drive assembly comprises a power output end, the power output end is in transmission connection to the drive arm, the drive assembly drives the power output end to reciprocate along a first direction, and the power output end drives the drive arm to drive the rotating arm to rotate.

19. The phase shifter according to claim 18, wherein the first direction is in a same plane as a symmetry axis of the arc-shaped segment, and is perpendicular to the symmetry axis of the arc-shaped segment.

20. The phase shifter according to claim 16, wherein the rotating shaft is located on the symmetry axis of the arc-shaped segment.
